(19) United States
(12) Patent Application Publication
(10) Pub. No.: US 2014/0328365 A1
(43) Pub. Date: Nov. 6, 2014

(54) MULTIFUNCTIONAL LASER DEVICE

(71) Applicant: FEMTOLASERS PRODUKTIONS GMBH, Korneauburg (AT)

(72) Inventors: Alexander Grujic, Leobersdorf (AT); Tuan Le, Vienna (AT); Andreas Stingl, Vienna (AT); Alfred Tomasch, Vienna (AT)

(21) Appl. No.: 14/358,589

(22) PCT Filed: Nov. 15, 2012
(86) PCT No.: PCT/AT2012/000291

§ 371 Date: May 15, 2014

Related U.S. Application Data
(60) Provisional application No. 61/561,365, filed on Nov. 18, 2011.

(30) Foreign Application Priority Data
Nov. 18, 2011 (AT) A 1717/2011

(51) Int. Cl. H01S 3/091; H01S 3/081

(52) U.S. Cl. CPC H01S 3/091; H01S 3/0811
USPC 372/70; 372/107

(57) ABSTRACT

A multifunctional laser device configured to be applicable as such in each of: multiple photon processes, nano structuring processes, optical coherence tomography, Terahertz (THZ) spectroscopy, THz imaging; or a combination of such processes; and comprising a mode-locked linear (X or Z-folded) fs laser resonator having a repetition rate of at least 300 MHz and 600 MHz at most and, thus, a corresponding short resonator length, said fs laser resonator further being a dispersive mirrors cavity having an average negative GDD (Group Delay Dispersion) in the spectral range of the laser operation, and being arranged to generate laser pulses with a pulse width of less than 30 fs, and comprising a pump laser operating at an optical output pump power of less than 2 W.

### FIELD OF INVENTION

In general, the invention relates to a multifunctional laser device comprising a mode-locked linear-cavity fs (femtosecond) pulse laser resonator.

In particular, the invention aims at an ultra-short pulse laser device which has a configuration such that it is apt for being used for several applications which may have different, even contrary device requirements, as e.g. with respect to optical output power, peak power and repetition rate. Accordingly, the invention seeks to provide a laser device which comprises an efficient trade-off between the various requirements so that one and the same device may be used for the different applications.

### BACKGROUND OF INVENTION

As to the various applications, in recent time, a lot of new and interesting applications in the field of optical technologies have been proposed, e.g. for diagnostic systems, for quality control, but also for nano structuring; particularly, optical coherence tomography (OCT), multiple photon (MP) processes as MP microscopy (MPM), but also MP polymerization (MPP) (in particular two photon (photo)polymerization (TPP), and Terahertz (THz) spectroscopy and THz imaging are of interest. At present, usually quite different light sources, i.e. laser devices, are used for these applications. Namely, for OCT, at present super luminescence diodes (SLD), swept sources and broadband Ti:Sa (Titanium:Sapphire, Al₂O₃)—laser sources are used; for THz spectroscopy, fiber lasers or standard 100 fs Ti:Sa-lasers are used; for MP processes, again fiber lasers or tunable 100 fs Ti:Sa-lasers are applied; and for TPP (also called TPA—two photon absorption) processes, fiber lasers and standard 100 fs Ti:Sa lasers are used.

Thus, it would be advantageous and extremely desirable to develop and provide a single laser device which is suited for all or at least almost all of the above purposes or functions, and which meets the respective demands, in particular with improved functions and results, in particular also e.g. for a combination of such processes, as for instance at a combination of several diagnosis methods (so-called “multimodal” diagnosis).

More in detail, SLDs are broadband coherent cw (continuous wave) light sources and, therefore, are not suited for other applications than OCT. Moreover, the center wavelength, a modulated shape of the spectral intensity if several SLDs are combined to increase spectral bandwidth and limited available power is negatively affecting axial resolution and scanning speed of Fourier Domain (FD)-OCT.

Then, Ti:Sa fs lasers usually provide pulses with a duration of about 100 fs and an average power of 1 to several Watt at a central wavelength of 800 nm. The repetition rate is about 80 MHz so that a pulse energy of about 10 to 20 nJ may be obtained. The then necessary power of the required pump laser, i.e. the “pump power”, is 5 W to greater than 10 W. These laser devices are rather large in size and weight (with a weight of about 40 kg for the laser and again about 40 kg for the electronics), have a high power consumption, and are in fact mostly applicable only in research. Due to the narrow spectral bandwidth (typically <10 nm FWHM) (FWHM—Full Width Half Maximum) and a slow tuning speed they are not interesting for OCT applications.

There are known Ti:Sa lasers with a repetition rate of 500 MHz or 1 to 2 GHz, too, compare EP 1 181 753 B, but the resonators thereof are ring resonators and extremely sensitive to environment influences, in particular temperature changes, so that these lasers may be used only in laboratory work. For instance, the operating temperature range for such a practical laser device which is known on the market as “Gigajet 20” can be chosen at 21° C.±5° C. and must be kept constant at the chosen value. Furthermore high pump power levels of 5 to 10 W are needed to compensate for weak self phase modulation (SPM) due to low energy per pulse at extremely high pulse repetition rates. Femto-second ring-cavity oscillators physically provide only one pass through a Kerr-lens arrangement within one round-trip inside the laser cavity. In the linear laser cavity the laser pulses pass the Kerr-lens arrangement twice before they leave the resonator which favours lower intra-cavity powers, hence lower pump power conditions.

Fiber fs lasers are rather compact and relatively light-weighted so that they are suited for mobile applications. However, they have a relatively low output power (not exceeding 100 mW significantly) so that they cannot be used in cases where higher (peak) power is needed—fiber lasers have a too less average power and a too long pulse duration (typically 100 fs). Therefore, they are rarely or never used for MPM and OCT.

### SUMMARY OF INVENTION

The present invention is now based on the perception that on the one hand, it is more favourable to limit the optical output power, also to avoid photo damaging of tissue or material, that is to have less average power, so that also a rather low pump power is sufficient, and to use rather low pulse energy (that is to provide for a rather high repetition rate), and, on the other hand, to operate with shorter pulses: Namely, it has been recognised that with pulses having a width a fifth of a given pulse width (e.g. 20 fs/100 fs)—in almost all of the above applications—the same result may be achieved at a fifth of the average power, at the same repetition rate, since the peak power is correspondingly higher. To obtain suitably short laser pulses at the specimen under investigation, it is then to be assured that the laser device maintains a small pulse width, i.e. does not suffer from an (excessive) increase of the pulse width, as in the case at a too high (positive) group delay dispersion (GDD) of the system. To this end, an adequate GDD management should be employed to maintain the short laser pulses at the specimen.

Therefore, it is an object of the invention to provide a laser device which has a small size and is compact so that it has the intended broad range of applications, which delivers low average power so that the energy consumption is low and a compact pump source (source of energy) of low expenditure can be used; which supports operations utilizing a broad spectral bandwidth, in the range of 50-200 nm FWHM, to be applicable for OCT purposes and short pulse applications, too; which generates pulses of sufficiently short widths, to achieve a high peak power levels due to the short pulse widths rather than due to a high average power; and which has a sufficiently high repetition rate to avoid photo damage of biolocigal samples but which is sufficiently low to secure stable laser operation, and to have sufficient time between the optical pulses so that fluorophores may revert to the fundamental state before the next pulse arrives (1-2 ns).

Accordingly, the present invention provides a multipurpose or multifunctional laser device configured to be applicable as such in each of: multiple photon processes, nano structuring processes, optical coherence tomography, Terahertz (THz) spectroscopy and THz imaging; or a combination of such processes; and comprising a mode-locked linear (X or Z-folded) fs laser resonator having a moderate high repetition rate of at least 300 MHz and 600 MHz at most and, thus, a corresponding short resonator length, said fs laser resonator further being a dispersive mirrors cavity having an average negative GDD (Group Delay Dispersion) in the spectral range of the laser operation, and being arranged to generate laser pulses with a pulse width of less than 30 fs, and comprising a pump laser operating at an optical output power of less than 2 W.

Preferably, all mirrors of the fs laser resonator, except the output coupler, are average negative dispersive mirrors over the operating wavelength range, this to achieve a large spectral bandwidth (>100 nm).

It should be mentioned here that for an output bandwidth of e.g. 40-100 nm FWHM, at a radiation at a central wavelength of about 800 nm±100 nm, it is not necessary that all mirrors are dispersive mirrors.

Then, preferably, the laser device is further configured to deliver a mode-locked average output power of less than 200 mW, for instance at pump power levels of 1-2 W.

The gain material, or laser crystal, respectively, of the laser device may be Ti:Sa.

Preferably, the pump laser comprises a frequency-doubled laser diode. Such a pump module is particularly advantageous in the case of a Ti:Sa laser crystal.

On the other hand, for specific purposes, it may be desirable that the laser resonator comprises a gain material which is selected from the group comprising Cr:LiSAF, Cr:LiCAF and Cr: Forsterite. Here, it is possible to simply use a laser diode as pump laser.

Preferably, in particular in the case of a Ti:Sa gain medium, the fs laser resonator is arranged to deliver laser radiation having a central wavelength of about 800 nm; advantageously, the radiation has a bandwidth greater than 100 nm.

It is further preferred that the repetition rate is 500 MHz at most.

It is further preferred that the output coupler is a partially reflective dispersive mirror.

Preferably, the laser resonator is configured to emit laser pulses with a peak power of at least 10 kW when considering the laser pulses with their shortest (bandwidth limited) pulse duration corresponding to their spectral bandwidth, e.g. after appropriate dispersion compensation.

With the present laser device it is advantageously possible that the laser resonator, preferably together with the pump laser, or a pump module, respectively, is contained in a hermetically sealed housing.

Then, the invention also concerns a combination of the present laser device with a dispersion compensation device, namely in particular for applications that benefit from high peak power.

With a configuration as defined, a rather high peak power may be achieved despite the increased repetition rate, when compared to oscillators according to the prior art; for instance, a peak power of 22 kW in the case of a repetition rate of 300 MHz and a pulse duration of 30 fs at a mode locked average output power of 200 mW; and a peak power of 33 kW in the case of 300 MHz repetition rate and 10 fs pulse duration and a mode locked average output power of 100 mW. In particular, for all MP processes, such a peak power is of high importance. Prior art devices allow to achieve e.g. 2 kW peak power at a 1 GHz repetition rate and a pulse duration of 50 fs (with a pump power of 1.7 W).

As to the application of the present laser device in MP processes (as for instance MPM, MPP, nano structuring, but also CARS—Coherent Anti-stokes Raman Spectroscopy), a preferred pulse duration of 15-30 fs (which corresponds to the absorption spectrum of fluorophores) and a preferred repetition rate of 300-500 MHz has been found out, with a limitation of the average power to about 30 mW at the specimen, to avoid photo damaging. A reduction of the radius of curvature (ROC) of the focussing mirrors (5, 6 in FIG. 1) from typically 50-100 mm to only 30 mm is possible; in accordance therewith, the length of the resonator arms may be reduced to ⅓- 1/10 of the arm length of prior art resonators, and the corresponding repetition rates are then in the above mentioned range, in particular between 300 and 600 MHz. Furthermore, instead of a pump laser power of ≧10 W, as at usual lasers, the pump power is limited to 2 W (maximum), which also means that the degree of outcoupling is reduced by a factor ⅕, down from 20-25% in case of standard repetition rates of 70-100 MHz, to 4-6% of the intra-cavity power in accordance with the higher repetition rate. The latter reduces the pulse energy available from the, but not within the oscillator (resonator). Thus, stable operation of the laser is still secured, namely also in the case of disturbing environment influences and temperature deviations.

With respect to a THz application, it should be mentioned beforehand that broadband THz radiation is mainly generated in LT-GaAs antennas. Here, the THz intensity (i.e. the maximum field in each pulse) is only a function of the antenna design, antenna material and of the bias voltage. Short laser pulses are capable of extending the THz bandwidth to higher THz frequencies. A high repetition rate can increase the average THz power without damaging the THz antenna and thus improves the S/N ratio. A limit is given by the dissipation of heat from the illuminated area. Therefore, the ideal light source should have a pulse energy which is just sufficient to excite all available carriers (transient conductivity) and, simultaneously, has a high repetition rate to run this process as often as possible per time unit.

At present OCT processes, a SLD delivers a continuous wave (cw) power of some mW to some 10 mW. In case of pulsed laser sources, pulses have to be streched in glass fibers until the peak power is significantly reduced in the case of ophthalmological or biomedical applications. Therefore, in the case of a 80 MHz laser pulse, the latter must be stretched to above 1 ns. To this end, about 100 m glass fiber are necessary. However, if a laser with higher repetition rate is used, a correspondingly less pulse stretching is necessary, and shorter fibers may be used. In the case of a 300-500 MHz repetition rate, it is sufficient to stretch the pulses proportionally less which simplifies the configuration.

Then, relatively high repetition rates of 300-600 MHz allow for transmission of a higher average power of ultra-short pulses in the case of delivery of ultra-short laser pulses through an optical fiber since pulse energy and, consequently, non-linearities which interfere with transmission in fibers are reduced. However, the repetition rate must have an upper limit as the intended peak power and pulse energy are to be taken into consideration. It has turned out that, again, an optimum repetition rate is in the range of 300-500 or 600 MHz.

### BRIEF DESCRIPTION OF DRAWINGS

The invention is now described in more detail with reference to preferred, advantageous embodiments, to which it should, however, not be limited, and to the attached drawings wherein

FIG. 1 shows the principle of a laser device comprising an X-folded resonator, in particular for MPM, THz and OCT applications;

FIG. 2 illustrates a corresponding laser device having a Z-folded resonator;

FIG. 3 is a schematic illustration of a standard (prior art) MPM setup;

FIG. 4 is a schematic illustration, similar to FIG. 3, of an MPM setup according to the invention;

FIG. 5 is an illustration of an exemplary experimental MPM setup;

FIG. 6 shows, in a diagram, the pulse duration dependent effect of GDD;

FIG. 7 shows, in a diagram, output pulse duration versus input pulse duration without dispersion (GDD) management;

FIG. 8 shows, in a diagram, GDD compensation with broadband chirped mirrors (dispersive mirrors);

FIG. 9 shows, in a diagram, the enhanced excitation efficiency, namely the intensity (in normalized units) vs. pulse duration (in fs), for a 10× objective;

FIGS. 10A and 10B illustrate comparative examples for microscope scans, namely (A) in FIG. 10A with shorter pulse duration T and less average power Pₐᵥ than (B) in FIG. 10B;

FIG. 11 shows an illustration of the electro-magnetic spectrum showing the THz gap;

FIG. 12 shows a schematic setup of a THz-TDS, with a Ti:Sa laser;

FIG. 13 schematically shows a setup for OCT;

FIG. 14 shows a diagram of axial resolution in retina (in μm) vs. FWHM bandwidth (in μm);

FIG. 15 shows a perspective view of a practical embodiment of the present laser device; and

FIGS. 16A and 16B show diagrams of the intensity of the integrated second harmonic generation (SHG)-signal of the laser pulse to be characterized vs. time and spectrum vs. wavelength for a tested embodiment of the present laser device.

### DETAILED DESCRIPTION OF THE DRAWINGS

FIG. 1 is a schematic illustration of a multi-purpose or multi-functional laser device 1 fit for several applications, that is one and the same laser device 1 can be used for the different applications as mentioned, for instance for MPM, THz and OCT.

The laser device 1 includes, in a manner known per se, a linear laser resonator 2 namely an X-folded laser resonator 2, and a pump laser 3 which is shown only schematically. The resonator 2 has a Ti:Sa laser crystal 4 as active laser or gain medium, as known per se, which is arranged between two semi-concave focussing mirrors 5, 6; at least mirror 5 is a dichroic mirror which is transmissive for the radiation 7 of the pump laser 3 which is transmitted via lens 8, but reflects the laser radiation 9 generated within the resonator 2. The laser crystal 4 serves as both, the gain medium as well as the necessary non-linearity supporting the known Kerr effect, to generate the intended mode-locked passive laser radiation 9, as is known per se. 10 and 11 denominate two dispersive (or chirped) mirrors, to ensure an average negative GDD in the spectral range of the laser operation. An outcoupler (OC) mirror 12 serves to couple out a small part of the radiation 9 during each round trip or oscillation, and to reflect back a greater part of this radiation. Preferably, this OC mirror 12 is a partially reflective dispersive mirror.

Then, an extra GDD management unit 13 is schematically shown in FIG. 1 in front of a fiber transmission unit 14 and a following application unit, as e.g. for MP-applications, THz, OCT. In the case of OCT, the unit 13 could also be dispensed.

The pump laser 3 may be a frequency-doubled Nd-doped diode pumped solid state (DPSS) laser, a frequency-doubled DBR-tapered diode laser with a pump power of 0.1-2 W, or an Argon-ion laser, as known per se.

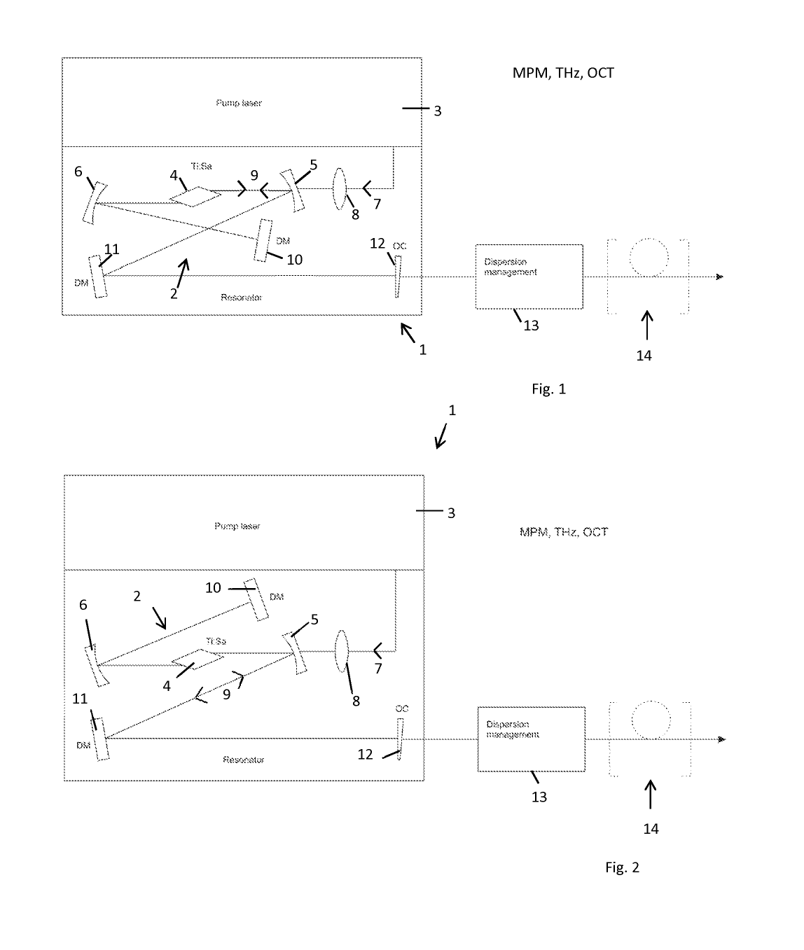

In similar manner, FIG. 2 illustrates a linear, namely Z-folded laser resonator 2 within a laser device 1 which, again, further comprises a pump laser 3 and an out-coupler mirror 12. The resonator 2 includes lens 8; semi-concave mirrors 5, 6; Ti:Sa laser crystal 4 and dispersive mirrors 10, 11. Furthermore, an extra GDD compensation unit 13 and a fiber transmission unit 14; to this fiber transmission unit 14, then an application unit, for instance MPM; THz, OCT, . . . (not shown), may be connected, similar as in the FIG. 1 case.

In the following, some applications of the present multifunctional laser device 1 will be described more in detail.

At first, reference is made to multiphoton microscopy (MPM) requirements.

Currently, tunable Ti:Sa based oscillators operating at repetition rates of 70-80MHz and delivering pulses in the 100 fs range are standard sources used in multiphoton microscopy. It has been perceived that shorter laser pulses can significantly benefit nonlinear microscopy in several ways:
(1) The excitation efficiency increases linearly with decreasing pulse duration. This dependence has been demonstrated experimentally both in the case of two-photon fluorescence microscopy and in the case of second harmonic generation microscopy for pulse durations down to less than 20 fs. Decreasing the pulse duration allows thus using lower average power and using potentially more cost effective and compact laser sources.
(2) The penetration depth increases with decreasing pulse duration at constant average power, owing to the increased excitation efficiency and improved contrast.
(3) Damage of samples that exhibit linear absorption can be prevented by employing lower average powers in conjunction with shorter pulses.
(4) The imaging contrast can be improved in samples that exhibit scattering and single-photon induced background by decreasing the pulse duration, since these adverse effects depend on the average power that can be reduced owing to the improved excitation efficiency with shorter pulses.

The large dispersion of microscopes and the limitation (high order dispersion) of traditional dispersion pre-compensation devices (such as prism- and grating-based compressors) have largely prevented the use of pulses significantly shorter than 100-fs in duration in nonlinear microscopy on a wide scale until now. The advent of high dispersion mirrors enables the delivery of pulses down to less than 15 fs via standard microscopes equipped with high-NA objectives. Mirror-based compressors are compact, user-friendly, high-throughput devices that are moderately priced making laser pulses with durations far below 100 fs widely available for nonlinear microscopy. Although the delivery of pulses as short as less than 10 fs at the sample of microscopes has been demonstrated, such extreme pulse durations (while certainly helpful for a restricted number of applications) remain impractical because of the extreme care that has to be taken in the dispersion compensation. Furthermore, the spectral bandwidth of sub-20-fs pulses covers the excitation bandwidth of several common fluorophores. One can thus conclude that pulses with durations in the range of 15-30 fs are ideally suited for nonlinear microscopy.

Photodamage is a major concern in multiphoton microscopy with biological samples. It has been demonstrated that this effect is of pure nonlinear nature in the femtosecond pulse range. Damage was shown to occur mostly as a consequence of multiphoton ionisation and free-electron-induced chemical bond breaking, mechanisms completely independent of thermal effects. It follows that the onset of damage sets an upper limit to the peak power, i.e. to the highest energy that can be delivered per pulse at a given pulse duration and given repetition rate. This results in turn in a limited amount of detectable nonlinear signal. This limitation can be circumvented by increasing the repetition rate. If this is done while keeping the pulse energy constant it results in higher average power which is inextricably linked to a larger, more complex and more expensive source. However, it has been found that preferably the repetition rate can be increased while decreasing both the pulse energy and pulse duration. Appropriate choice of these parameters will result in efficient, damage-free excitation of the sample at comparatively lower average powers.

It has been demonstrated that by employing sources with a repetition rate of 1 GHz photodamage effects can be mitigated; both in the case of second harmonic generation microscopy and two-photon fluorescence microscopy samples could be exposed (without inducing photodamage or photobleaching) to higher average powers as compared to 70 MHz sources having the same pulse duration and energy. However, at a repetition rate of 1 GHz the period of the pulse train is 1 ns while the relaxation times of the excited states of fluorescent in biological tissue are typically in the region of a few nanoseconds. Consequently, given the overlap of excitation with residual fluorescence signal at this repetition rate, the results from fluorescence-life-time multi-photon microscopy are affected and reproducibility and interpretability of the results may be seriously questioned. Furthermore, irradiation with pulses at time intervals shorter than the relaxation time is expected to result in excited state absorption increasing the risk of damage and rending the interpretation of the measurements complex. This can be prevented by increasing the delay between adjacent pulses to approximately 2-3 ns which corresponds to repetition rates of approximately 300-500 MHz.

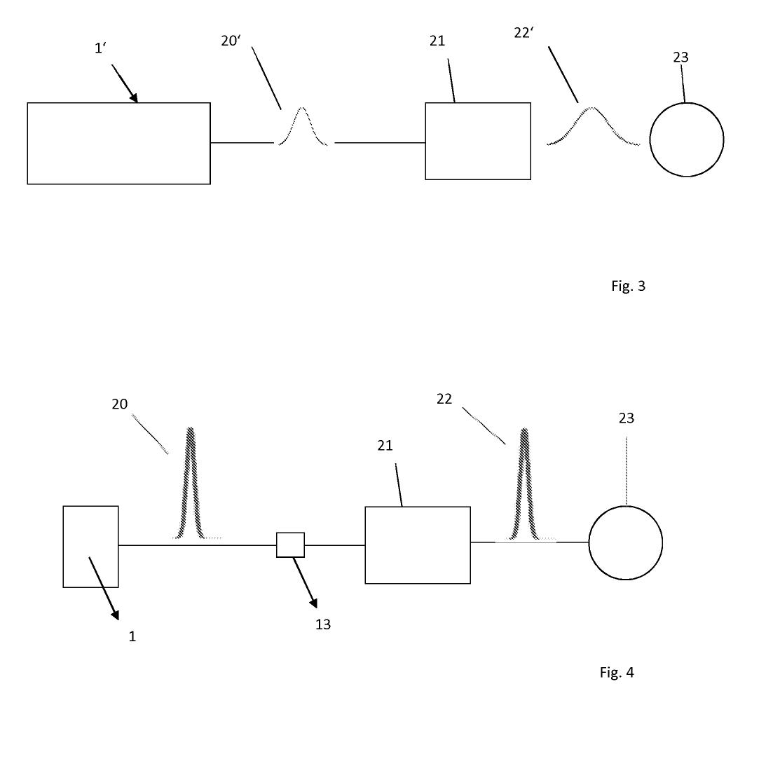

In FIG. 3 a standard MPM setup is shown which comprises a tunable 80 MHz oscillator device 1′ delivering pulses in the 100 fs range; 20′ denotes an input pulse having a duration in the 100 fs range, and 21 denotes a microscope having a positive dispersion (GDD) typically between 5000 and 15000 fs². Accordingly, the pulses are stretched, as is schematically shown at pulse 22′ at a sample 23 (at the focus of the microscope), namely to a typical duration between 150 and 500 fs.

Contrary to this, FIG. 4 schematically shows an MPM setup according to the invention, with a 300-600 MHz oscillator device 1 delivering pulses 20 in the 15-30 fs range. Then, a mirror-based dispersion (GDD) pre-compensation unit 13 (cf also FIG. 1) having a negative dispersion between −5000 and −15000 fs² may be used. 21 again denotes a microscope having positive dispersion (GDD) typically between 5000 and 15000 fs². Thereafter, the pulse 22 at the sample 23 (at the focus of the microscope) has a typical duration below 30 fs, this contrary to FIG. 3, and due to the GDD management as described.

FIG. 5 shows somewhat more in detail such an MPM setup. This setup comprises the laser device 1, the GDD compensation unit 13 based on DMs (dispersive mirrors), to introduce the necessary negative GDD for pre-compensating the positive GDD of the microscope 21 comprising an auto-correlator 24 for pulse characterization, a telescope 25, a scan objective 26, a tube lens 27 and an objective 28.

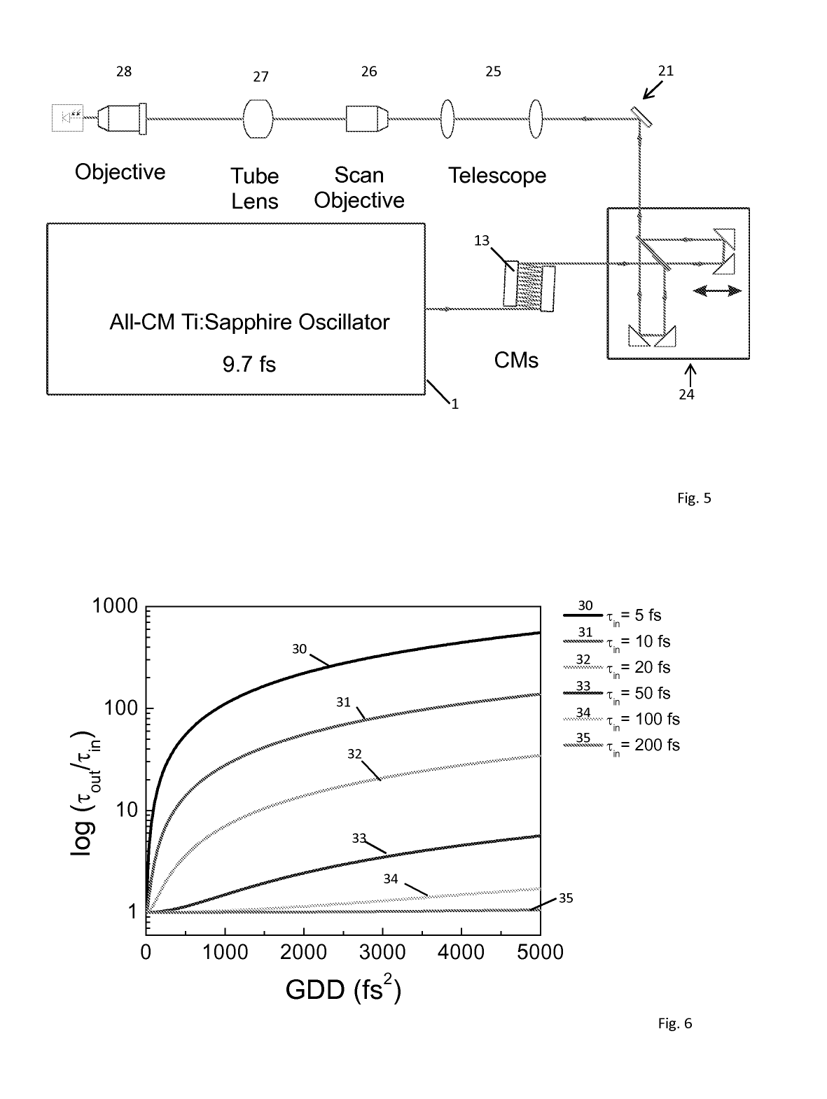

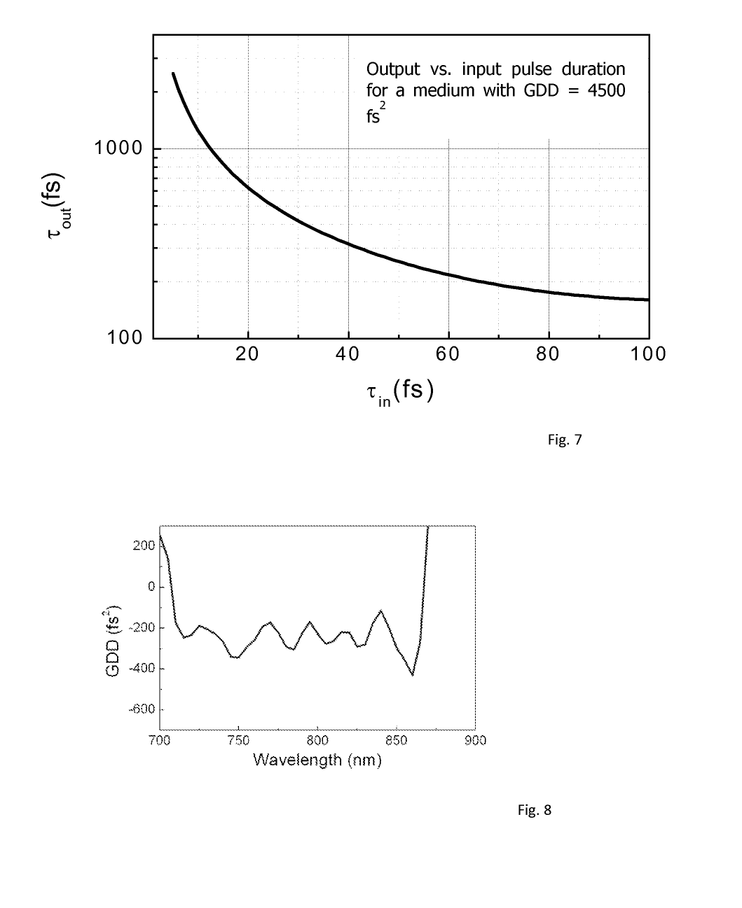

In FIG. 6, a diagram showing log of the ratio of the pulse duration τₒᵤₜ of output pulses and that, τᵢₙ, of input pulses vs GDD (in fs²) is illustrated for several input pulse durations τᵢₙ, namely 5 fs (graph 30), 10 fs (graph 31), 20 fs (graph 32), 50 fs (graph 33), 100 fs (graph 34), and 200 fs (graph 35). It is to be seen that the adverse effect of the—positive—GDD on the pulse duration is the more remarkable the shorter the pulse duration is. Therefore, to be able to use pulses of ultra-short width, e.g. about 30 fs, it is recommendable to provide for compensation of the positive GDD introduced in particular by the microscope 21. This is similar as in case of the laser device 1, where positive GDD as caused e.g. by the crystal 4 and by the air in the resonator 2 have to be compensated, and this may be done by using dispersive mirrors 10, 11, etc.

As an example, FIG. 8 shows the effect of a usual broadband DM (dispersive mirror) for GDD compensation, namely in the wavelength range of 800 nm. As may be seen, low reflectance losses and GDD values of −300 fs²/bounce can be achieved in the spectral range 720-860 nm with dispersive mirrors known per se.

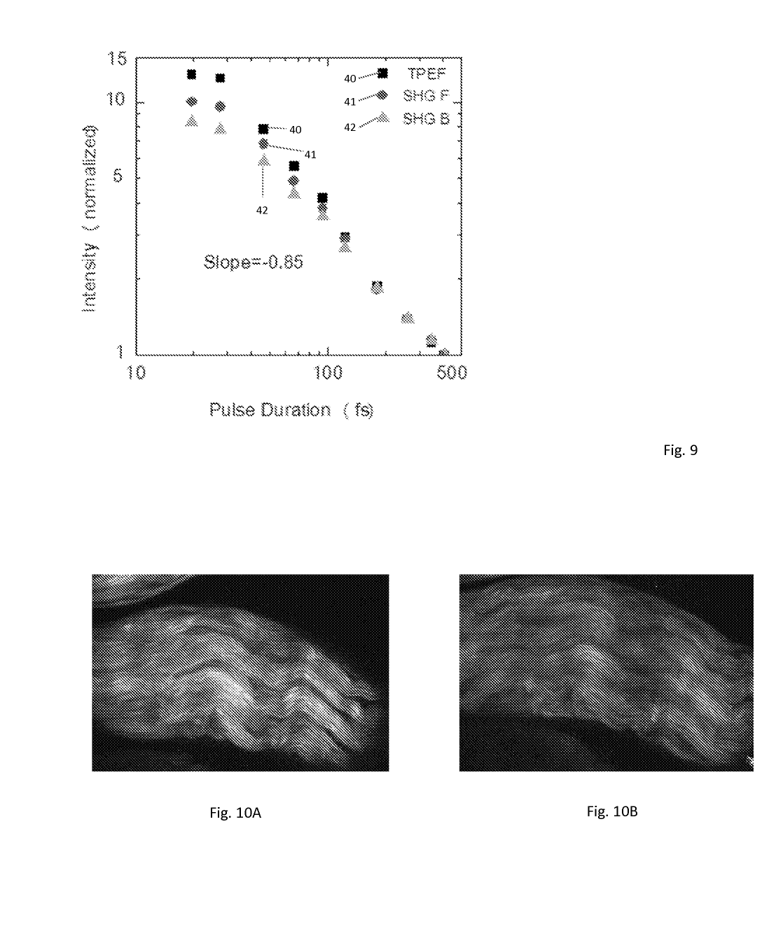

The favourable effect of a short pulse duration on the intensity (or power) of signals, namely two photon emission fluorescence, TPEF (symbols 40) and SHGF and B (second harmonic generation forward and backward; symbols 41 and 42) may be seen from FIG. 9 where the intensities of TPEF and SHG versus pulse duration obtained with 10× objectives are shown. The squares 40 are for TPEF signals from dilute fluorescein solution. The circles 41 and triangles 42 are for SHG signals from rat-tail tendon in forward and backward detections, respectively.

Then, a comparison of FIGS. 10A and 10B proves that a stronger fluorescence signal can be generated at lower average power by employing shorter laser pulses. A pair of DMs was employed to compensate 12000 fs² (the dispersion of a standard scanning microscope) at 780 nm. In the absence of dispersion management the pulses are >400 fs at the sample. The images show collagen in a rat tail sample (measured data C/O J. D. McMullen and W. Zipfel, Cornell University).

Next, it is referred to a THz application of the present laser device 1.

As may be gathered from FIG. 11, terahertz (THz) radiation refers to electromagnetic waves propagating at frequencies in the range of 10¹² Hz. Many materials are transparent to THz. THz radiation is safe for biological tissues because it is non-ionising (unlike for example X-rays), and images formed with terahertz radiation can have relatively good resolution (less than 1 mm). Also, many substances have unique spectral fingerprints in the terahertz range, which means that terahertz radiation can be used to identify the structure of some materials. The successful demonstration base-on THz technology includes several different types of explosives, polymorphic forms of many compounds used as Active Pharmaceutical Ingredients (API) in commercial medications as well as several illegal narcotic substances. Since many materials are transparent to THz radiation, these items of interest can be observed through visually opaque intervening layers, such as packaging and clothing.

One cannot see this terahertz emission because its frequency is about 300 times smaller than the visible spectrum of humans. Neither can one feel it since the total intensity emitted at all frequencies below 1 THz is less than a millionth of a watt per square centimeter. Therefore, generating and detecting the THz radiation became a worldwide challenge for specialists. The free electron laser or synchrotron light sources can generate bright THz radiation, however, both are very costly and bulky based on the accelerator infrastructure, so as to be unavailable for commercial application. Another approach is based on vacuum electronics, such as Gyrotron and back-wave oscillators; however, the former device emits radiation only in the range between 0.02 to 0.25 THz, while only up to 1 THz at maximum for the later. Besides, both above two devices are limited to the vacuum-tube technology, for which hazard high voltages are mandatory. The semiconductor nanotechnologies give an approach to obtaining THz based on the quantum states of holes (p-Germanium laser) or electrons in subband of semiconductor (quantum cascade laser). The above two items can generate continuous THz wave, but need cryogenic temperature and high vacuum condition, which restricts it so that it cannot be widely used out of the laboratory.

Ti: Sa lasers that can generate pulses of visible or near-infrared light (around 10¹⁴-10¹⁵ Hz) with a duration less than 100 fs are increasingly common, and can, with small incremental costs, be used to generate and detect terahertz radiation. The setup is called THz-time domain spectroscopy (THz-TDS). One common method is called photoconductive emitter. An electric field of about 10⁶ Vm⁻¹ is generated in a high-resistance semiconductor by applying a DC voltage between a pair of electrodes bonded to its surface. A femtosecond laser pulse illuminates the semiconductor between the electrodes, creating a large density of mobile charge carriers (electrons and “holes”) through an effect that is closely related to the photoelectric effect used in solar cells. These charge carriers, sensing the large electric field, accelerate at roughly 10¹⁷ ms⁻². All accelerating charges emit electromagnetic radiation. These charge carriers, reaching their maximum velocity in less than 10⁻¹² s, emit a single electric-field pulse shorter than 10⁻¹² s that contains a broad range of frequencies, up to a few terahertz. Typically, the average power generated by this method is in a stable, coherent beam with well-known temporal characteristics, and it can be used for spectroscopy with high spectral resolution and excellent signal-to-noise ratio, and even for imaging.

Another method is called optical rectification: A high-intensity ultrashort laser pulse passes through a transparent crystal material that emits a terahertz pulse without any voltages applied. When the applied electric field is delivered by a femto-second-pulse-width laser, the spectral bandwidth associated with such short pulses is very large. The mixing of different frequency components produces a beating polarization, which results in the emission of electromagnetic waves in the terahertz region. The EOR effect is somewhat similar to a classical electro-dynamic emission of radiation by an accelerating/decelerating charge, except that here the charges are in a bound dipole form and the THz generation depends on the second order susceptibility of the nonlinear optical medium. This is a popular method for generating radiation in the few THz up to the few 10 THz range.

In THz-TDS, the electrical field of the THz pulse interacts in the detector with a much-shorter laser pulse (e.g. 100 femtoseconds) in a way that produces an electrical signal that is proportional to the electric field of the THz pulse at the time the laser pulse gates the detector on. By repeating this procedure and varying the timing of the gating laser pulse, it is possible to scan the THz pulse and construct its electric field as a function of time. Subsequently, a Fourier transform is used to extract the frequency spectrum from the time-domain data. Two common detection schemes are used in THz-TDS: photoconductive sampling and electro-optical sampling. Photoconductive detection is similar to photoconductive generation. Here, the bias electrical field across the antenna leads is generated by the electric field of the THz pulse focused onto the antenna, rather than being applied externally. The presence of the THz electric field generates current across the antenna leads, which is usually amplified using a low-bandwidth amplifier. This amplified current is the measured parameter which corresponds to the THz field strength. Again, the carriers in the semiconductor substrate have an extremely short lifetime. Thus, the THz electric field strength is only sampled for an extremely narrow slice (in the order of femtoseconds) of the entire electric field waveform. The electro-optic sampling detection is by using the Pockels effect, where certain crystalline materials become birefringent in the presence of an electric field. The birefringence caused by the electric field of a terahertz pulse leads to a change in the optical polarization of the detection pulse, proportional to the terahertz electric-field strength. With the help of polarizers and photodiodes, this polarization change is measured.

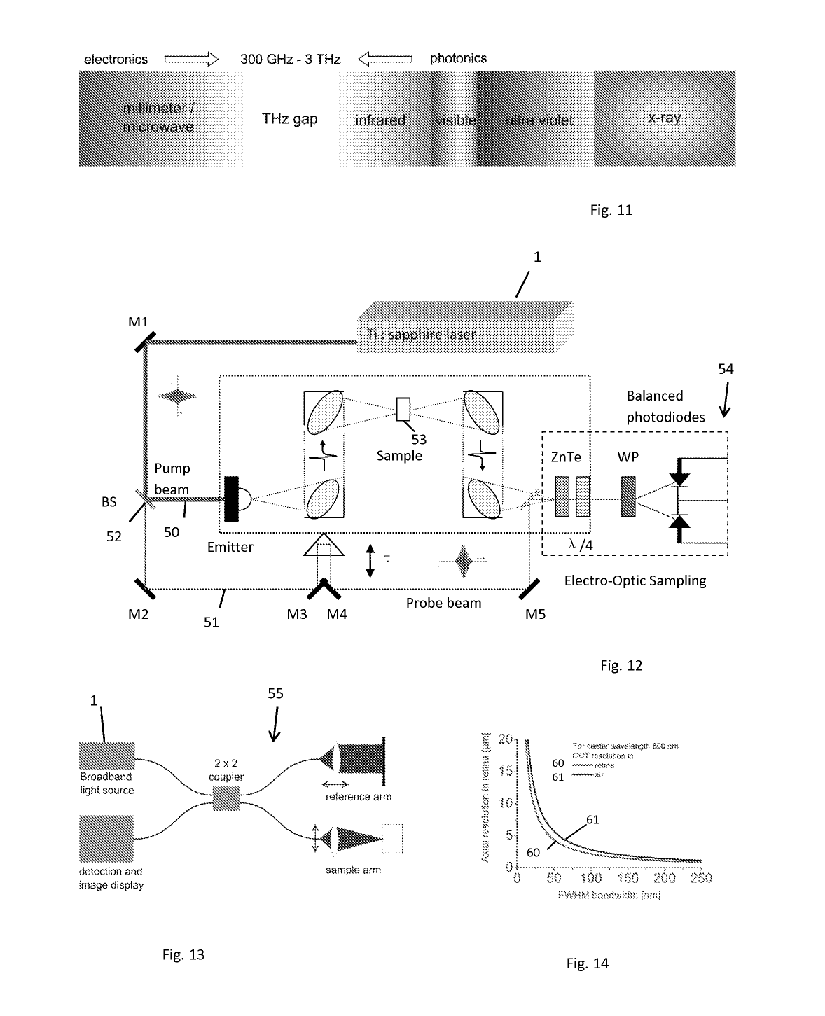

Herein, one can understand that Ti:Sa lasers play a key role in the THz-TDS technology. Due to the rapid emerging from industrial demand and scientific research, people need a compact THz-TDS and THz image system. Conventional ultrafast time-domain spectroscopy is based on pump-probe schemes, cf. FIG. 12, in which a single femtosecond (fs)-laser 1 provides pump pulses 50 and probe pulses 51 separated by a beam splitter 52. The prior art Ti:Sa laser oscillators need water-chiller and a relatively longer cavity since they work below hundred Hertz repetition rate. Therefore, a compact Ti:Sa laser 1 can solve this problem and make the THz-TDS system a portable instrument. Normally, the response bandwidth is at the range from 0.1 to 4 THz and any Ti:Sa system emitting the laser pulse duration below 100 fs are adaptable for the setup. Along with the progress in generation of multi-THz pulses, field-resolved detection has developed. This generation mechanism of THz radiation may be understood as a phase matched 2^{nd} order nonlinear-optical process. Herein, one can find the sub-20 fs laser system 1 is the key instrument for the ultra-broadband THz setups. Furthermore, the high-speed asynchronous optical sampling circumvents these problems by eliminating mechanical delay scanning devices from ultrafast time-domain spectroscopy systems. To this end, two femtosecond lasers 1 with repetition rates f_{R} are employed that are stabilised at an offset of Δf. The faster laser serves as the pump laser, the slower one as the probe laser. As result of the detuning, successive pairs of pump and probe pulses arrive at the sample 53 with a delay that incrementally increases by 10 fs with each pulse pair. Thus, the delay between pump 50 and probe 51 pulses is linearly ramped from 0 to 1 ns. The ramp is reset to zero whenever the faster pump laser ‘overtakes’ the probe laser after exactly 100 μs (the inverse of Δf_{R}) and a new measurement cycle starts. The time-delay T as function of real-time t is given by a straight-forward linear relation: τ=(Δf/f_{R})×t. Therefore, a high repetition rate of laser leads to a higher frequency resolution.

At 54 in FIG. 12, an electro-optic sampling device with balanced photodiodes, as is known per se, is shown, too.

Then, optical coherence tomography (OCT) is a non-invasive, optical diagnostic imaging modality enabling in vivo cross-sectional tomography, 3-D visualization of internal tissue microstructure. OCT is analogous to ultrasound B-mode imaging except that it uses light; therefore achieving unprecedented image resolutions, i.e., sub-cellular resolution scale, or approximately 10 times better results than conventional ultrasound by exploiting the short temporal coherence of light from broad bandwidth light sources in combination with low coherence interferometry. Unlike other non-linear optical measurement techniques, e.g. multi-photon or CARS microscopy, it is not utilizing the peak power or peak intensity of the light but solely the fact that coherence time decreases as bandwidth of light increases allowing for interferometric detection of very small distances between adjacent scatterers (i.e. axial resolution, cf FIG. 14). The light source can be operated in cw or pulsed mode regardless of its repetition rate. Only the FWHM bandwidth and shape of the spectral intensity but also optical noise determine the achievable axial resolution. In theory 1.5 μm resolution in tissue can be reached if a Gaussian spectral intensity profile with 150 nm FWHM bandwidth is used.

As medical diagnostic technology, OCT is being investigated for applications in a number of medical fields including ophthalmology, cardiology, and gastroenterology. Frequency domain (FD) OCT has caused a paradigm change in the OCT community since it has been shown to have huge advantages in terms of sensitivity and acquisition speed. Two variants of FD OCT exist: the spectrometer based spectral-domain (SD) OCT technique dominating in the wavelength regime of 780-850 nm, and swept source OCT dominating in the wavelength ranges around 1050 nm and 1300 nm.

The performance of an OCT system is mainly determined by its axial resolution 60 or 61 (s. FIG. 14), transverse resolution, dynamic range (i.e. sensitivity) and data acquisition specifications. With typical resolution of 10 μm OCT already provides significantly more detailed structural information than any other conventional clinical imaging technique. Recently high-end ophthalmologic OCT devices have already achieved 5 μm axial resolution in tissue with scanning speeds up to 26.000 A-scans (axial) per second. Their performance (speed and resolution) is mainly determined by commercially available broadband light sources at 800 nm (mostly SLDs) with useful output power in the 10 mW to 20 mW range.

OCT with higher resolution and speed would potentially have great impact in diagnosing diseases in such fields as ophthalmology, cardiology, gastroenterology, or oncology. High-speed axial scanning in OCT became possible by the advent of high-speed CMOS cameras. Axial scans up to 312.000 scans per second were demonstrated by a renowned group at MIT using a conventional Ti:Sa laser system (cf Benjamin Potsaid, Iwona Gorczynska, Vivek J. Srinivasan, Yueli Chen, James Jiang, Alex Cable, and James G. Fujimoto, “Ultrahigh speed Spectral/Fourier domain OCT ophthalmic imaging at 70,000 to 312,500 axial scans per second”, Opt. Express 16, 15149-15169 (2008)). Due to the very fast scanning more light power has to be collected from the sample (or the eye) which cannot be provided by a super luminescent LED (SLD). Advantages of high acquisition speeds are densely sampled three-dimensional OCT (3D-OCT) and/or improved lateral resolution due to reduced motion artefacts of the patient. In fact Fourier domain OCT with high-speed cameras has revolutionized OCT technology. It allows high-speed scanning without the implementation of any mechanical moving components, e.g. stages, polygon mirrors or tunable Fabry Perot filters, as required in the case of using swept light sources.

Fast scanning in combination with an asymmetric interferometer 55 (cf. FIG. 13) which supports higher signal throughput on the cost of reduced throughput from the source to the sample increases the demand in power from the source to 10-50 mW. This power level in combination with a Gaussian shaped spectrum of >100 nm FWHM, centered at 800 nm is ideally delivered by a compact mode-locked Ti:S oscillator 1 with a repetition rate as high as possible in order to reduce peak power, as already outlined above.

Finally, it is referred to higher repletion rate and fiber delivery applications.

Ultrashort laser pulses travelling through optical fibers are not only affected by material dispersion but are also subject to nonlinear effects due to their confinement to the rather small core of the waveguide. The propagation of optical pulses through an optical fiber is usually described by two parameters called the non-linear length L_{NL} and the dispersion length L_{D}.

$${L}_{D} = - \frac{2 {⊓}_{c}}{{⊓}^{2}} \frac{{⊓}^{2}}{D} {L}_{NL} = \frac{{A}_{eff} □}{2 □ {n}_{2} P}$$

where D is the fiber dispersion, τ denotes the undistorted pulse duration, λ the center wavelength, Aeff the effective area, P is the peak power and μ₂ is the nonlinear refractive index. If L_{D} is much smaller than L_{NL} the pulses get linearly stretched or compressed depending on their initial chirp. They see the fiber more or less as a bulk transparent. In contrast, if L_{NL} is shorter than L_{D} the pulses are subject to spectral broadening or spectral narrowing and lose their capability to exit the fiber with the initial pulse duration. In order to avoid nonlinear effects the pulse peak power P shall be kept as small as possible to increase L_{NL} over L_{D}. In this case linear stretching occurs in a shorter time scale, thus preventing nonlinear interactions to evolve significantly. Hence the output power at the end of a short pulse fiber delivery is basically restricted by the pulse peak power.

For femtosecond lasers with a given pulse duration the pulse peak intensity inside the fiber is adjusted by the average output power of the laser. Therefore, since the pulse peak power is inversely proportional to the laser pulse repetition rate, the fiber output power can be accordingly increased with increasing the laser repetition rate while keeping the same peak intensity inside the fiber. For instance a twice higher repetition rate at the same average output power of the laser reduces the pulse peak power to its half, which means restoring the same pulse peak power as of the lower repetition rate, a twice higher average power through the fiber can be transmitted.

To sum up, ultrashort pulses from Ti:Sa lasers have found spread applications in the field of spectroscopy, nano-/micro materials processing or THz generation for instance where the sharp rise in the light electric field or the peak power of the pulse is most important. Recently great interest for fiber delivery for such intense optical pulses emerges since it gives much flexibility for laser integration or allows access to steadily moving, difficult attainable regions or under adverse environmental conditions. Fiber delivery was successfully shown for three-dimensional high resolution imaging in nonlinear optical microscopy, S. L. Fu, X. Gan, and M. Gu, “Nonlinear optical microscopy based on double-clad photonic crystal fibers,” Opt. Express 13, 5528-5534 (2005). It also has decisive impact on multiphoton endoscopy and potentially extends the capability of coherent anti-Stokes Raman scattering (CARS) to endoscopic applications, S. H. Wang, T. B. Huff, and J. -X. Cheng, “Coherent anti-Stokes Raman scattering imaging with a laser source delivered by a photonic crystal fiber,” Opt. Lett. 31, 1417-1419 (2006). In the field of Terahertz science fiber-coupled THz emitters and receivers were employed for ultrafast coherent spectroscopy, S. A. Crooker, “Fiber-coupled antennas for ultrafast coherent terahertz spectroscopy in low temperatures and high magnetic fields”, Rev. Sci. Instrum. Volume 73, Issue 9, pp. 3258-3264 (2002). Up to now the average optical output power from a state-of-the-art fiber delivery is strongly limited due to the afore mentioned nonlinearities. The increase of the laser's repetition rate will proportionally make more optical power available for fiber based applications.

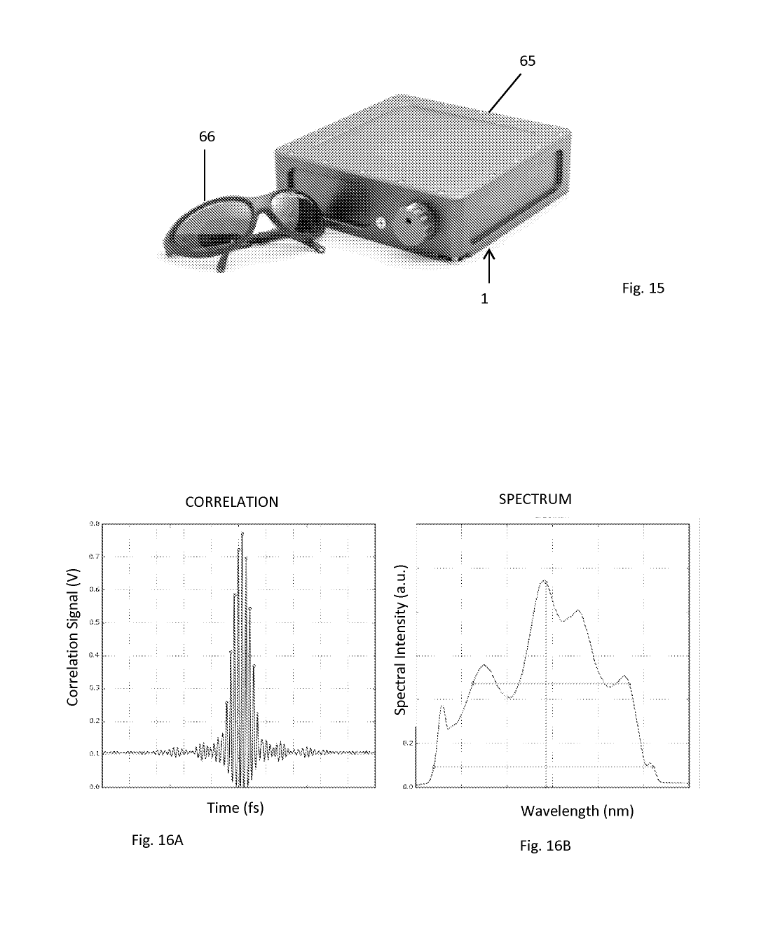

Reference is now made to FIG. 15 which shows a practical laser device 1 designed in accordance with the above teachings. This laser device 1 has a hermetically sealed housing 65 which contains the laser resonator 2 (cf. FIGS. 1, 2) and preferably also the pump laser (module) 3. To demonstrate the compact, small sized device unit, conventional laser protective glasses 66 are illustrated, too.

The respective specific parameters of this practical laser device 1 are as follows:

Mode locked average output power=100 mW

Pulse duration=8.5 fs

Bandwidth=171 nm FWHM

Repetition rate=330 MHz

Pump Power=1.1 W

Peak Power=35 kW

Center wavelength=793 μm.

Corresponding graphs showing measured correlation (vs. time) and spectrale intensity (vs. wavelength) for this practical laser device 1 as mentioned above are shown in FIG. 16A and FIG. 16B.

From the foregoing, it will be noted that, with the present invention, a multifunctional laser device 1 is provided which has a configuration such that one and the same device 1 may be used in very different applications, namely in MP processes (including MPM processes, MPP processes, TPP processes, nano structuring processes, but also CARS processes), in OCT processes, in fiber delivery cases, and in THz processes; the configuration comprises a mode-locked linear fs resonator, also called cavity or oscillator, for generating fs laser pulses with a duration of less than 30 fs; the length of the laser radiation path in this fs laser resonator is dimensioned such that a repetition rate of between 300 and 600 MHz (or preferably between 300 and 600 MHz) is given; the laser resonator includes at least some dispersive mirrors (DMs) with negative GDD so that the average GDD of the resonator in the spectral range of operation is negative; there is provided a pump laser the optical output power of which is limited to 2 W at most. In the case of an embodiment of the laser device where the bandwidth is less than 100 nm, e.g. is between 40 and 100 nm, with an exemplary center wavelength of 800 nm±100 nm, it is sufficient that some of the mirrors of the resonator are DMs; in case of a broader bandwidth, preferably >100 nm FWHM at 800 nm, it is preferred that all mirrors of the resonator (of course with the exception of the out-coupler) are DMs. The average output power of the resonator is relatively low, namely preferably less than 200 mW whereas the peak power of the laser pulses amounts at least 10 kW. The pump laser is preferably a modern pump laser comprising a frequency-doubled semiconductor laser diode or a frequency doubled DPSS laser.

1. A multifunctional laser device (1) configured to be applicable as such in each of: multiple photon processes, nano structuring processes, optical coherence tomography, Terahertz (THZ) spectroscopy, THz imaging; or a combination of such processes; and comprising a mode-locked linear fs laser resonator (2) having a repetition rate of at least 300 MHz and 600 MHz at most and, thus, a corresponding short resonator length, said fs laser resonator (2) further being a dispersive mirrors cavity having an average negative Group Delay Dispersion in the spectral range of the laser operation, and being arranged to generate laser pulses with a pulse width of less than 30 fs, and comprising a pump laser (3) arranged to operate at an optical output pump power of less than 2 W.

2. The laser device of claim 1, wherein all mirrors (10, 11) of the fs laser resonator, except the output coupler, are dispersive mirrors.

3. The laser device of claim 2, wherein the output coupler (12) is a partially reflective dispersive mirror.

4. The laser device of any one of claims 1 to 3, further configured to deliver a mode-locked average output power of less than 200 mW.

5. The laser device of any one of claims 1 to 4, further comprising Ti:Sa as gain material (4).

6. The laser device of any one of claims 1 to 5, wherein the pump laser comprises a frequency-doubled laser diode.

7. The laser device of any one of claims 1 to 4, wherein the laser resonator (2) comprises a gain material which is selected from the group comprising Cr:LiSAF, Cr:LiCAF and Cr: Forsterite.

8. The laser device of claim 7, wherein the pump laser (3) is a laser diode.

9. The laser device of any one of claims 1 to 8, wherein the fs laser resonator (2) is arranged to deliver laser radiation having a central wavelength of about 800 nm.

10. The laser device of claim 9, wherein the radiation has a bandwidth greater than 100 nm.

11. The laser device of any one of claims 1 to 10, wherein the repetition rate is 500 MHz at most.

12. The laser device of any one of claims 1 to 11, wherein the laser resonator (2) is configured to emit laser pulses with a peak power of at least 10 kW when considering the laser pulses with their shortest (bandwidth limited) pulse duration corresponding to their spectral bandwidth, e.g. after appropriate dispersion compensation.

13. The laser device of anyone of claims 1 to 12, wherein the laser resonator (2) is contained in a hermetically sealed housing (65).

14. The laser device of any one of claims 1 to 13, wherein the laser resonator (2) and a pump module (3) are contained in a hermetically sealed housing (65).

15. The laser device of any one of claims 1 to 14, in combination with a dispersion compensation device (13), for applications that benefit from peak power.
